(19) United States
(12) Patent Application Publication
(10) Pub. No.: US 2016/0345790 A1
(43) Pub. Date: Dec. 1, 2016

(54) DUST COLLECTOR FOR CLEANER AND CLEANER HAVING THE SAME

(71) Applicants: Jiangsu Midea Cleaning Appliances Co., Ltd., Suzhou (CN); Midea Group Co., Ltd., Foshan (CN)

(72) Inventors: Baoquan YANG, Suzhou (CN); Xiahu XIAO, Suzhou (CN)

(21) Appl. No.: 14/783,678

(22) PCT Filed: Apr. 10, 2014
(86) PCT No.: PCT/CN2014/075114

§ 371 Date: Oct. 9, 2015

(30) Foreign Application Priority Data
Apr. 11, 2013 (CN) 201320182440.4

(51) Int. Cl. A47L 9/16; B04C 9/00; B04C 5/185

(52) U.S. Cl. CPC A47L 9/1608; B04C 5/185; B04C 9/00; B04C 2009/004

(57) ABSTRACT

A dust collector for a cleaner and the cleaner are provided, and the dust collector includes: a dust-collection container defining an inner chamber therein and having a dust-laden air inlet and air outlet; a cyclone barrel disposed in the inner chamber and having an air inlet formed in a side wall of the cyclone barrel; a dust-laden air tube defining a first end connected to the dust-laden air inlet and a second end connected to the cyclone barrel air inlet; and a dust baffle disposed between an outer wall of the cyclone barrel and an inner wall of the dust-collection container to cover up a dust depositing area formed between the outer wall of the cyclone barrel and an outer wall of dust-laden air tube.

### CROSS REFERENCE TO RELATED APPLICATION

This application claims priority and benefits of Chinese Patent Application No. 201320182440.4, filed with State Intellectual Property Office on Apr. 11, 2013, the entire content of which is incorporated herein by reference.

### FIELD

Embodiments of the present disclosure generally relate to a household appliance, more particularly, to a dust collector for a cleaner and a cleaner having the same.

### BACKGROUND

The dust collector in the related art includes a dust-collection container, a cyclone barrel disposed in the dust-collection container, a filter disposed in the cyclone barrel and a dust-laden air tube communicating the filter with the dust-collection container. In the dust collector in the related art, a dust depositing area is formed between an outer wall of the cyclone barrel and an outer wall of dust-laden air tube, such that the dust discharged from the cyclone barrel via air holes tends to be deposited in the depositing area. Since the cyclone barrel and the dust-collection container are fixed together, it is difficult to clean the dust in the depositing area.

### SUMMARY

Embodiments of the present disclosure seek to solve at least one of the problems existing in the related art to at least some extent.

Accordingly, an embodiment of the present disclosure is to provide a dust collector for a cleaner.

Another embodiment of the present disclosure of the present disclosure is to provide a cleaner including the dust collector.

A dust collector according to embodiments of the present disclosure includes: a dust-collection container defining an inner chamber therein and having a dust-laden air inlet and air outlet; a cyclone barrel disposed in the inner chamber and having an air inlet formed in a side wall of the cyclone barrel; a dust-laden air tube defining a first end connected to the dust-laden air inlet and a second end connected to the cyclone barrel air inlet; and a dust baffle disposed between an outer wall of the cyclone barrel and an inner wall of the dust-collection container to cover up a dust depositing area formed between the outer wall of the cyclone barrel and an outer wall of dust-laden air tube.

With the dust collector of the embodiments of the present disclosure, by disposing the dust baffle between an outer wall of the cyclone barrel and an inner wall of the dust-collection container, the dust collected in the dust-collection container is blocked and prevented from entering and depositing in the depositing area, so that the dust collector is easy to clean.

In some embodiments, an included angle formed between the outer wall of the cyclone barrel and the outer wall of dust-laden air tube within the dust depositing area is smaller than 90 degrees.

In some embodiments, the dust baffle is connected with the outer wall of the cyclone barrel and contacted with the inner wall of the dust-collection container, thus simplifying the structure of the dust-collection container and facilitates molding and assembling the dust-collection container.

In some embodiments, the dust baffle is connected with the inner wall of the dust-collection container and contacted with the outer wall of the cyclone barrel, thus simplifying the structure of the cyclone barrel and facilitates molding and assembling the cyclone barrel.

In some embodiments, the dust baffle is disposed in a vertical direction. Thus, the structure of the dust baffle is simplified, which facilitates mounting the dust baffle and improves the mounting efficiency.

In some embodiments, an upper end of the dust baffle is inclined toward the dust-laden air tube. Thus, the dust can be prevented from entering into the dust depositing area from above thereof, which avoids dust being deposited in the dust depositing area and facilitates washing.

In some embodiments, the upper end of the dust baffle is connected with the outer wall of the dust-laden air tube, thus further avoiding dust entering into the dust depositing area.

In some embodiments, a filter is disposed in the dust-collection container and has a filtering cup and a flange disposed on an upper end of the filter cup, the flange is connected with an inner wall of the dust-collection container so as to divide the inner chamber into a first chamber communicated with the air outlet and a second chamber, in which the cyclone barrel is disposed in the second chamber, a lower end of the filter cup is extended into the cyclone barrel through an open upper end of the cyclone barrel, and the open upper end of the cyclone barrel is spaced apart from a lower surface of the flange.

In some embodiments, a distance between the lower surface of the flange and the upper end of the cyclone barrel ranges from 10 mm to 35 mm. Thus a dust collection capacity of the dust collector is further improved. In addition, it is easy to assemble the dust collector and the assembling efficiency of the dust collector is improved.

In some embodiments, a plurality of air holes are formed in a bottom wall of the cyclone barrel and away from the air inlet of the cyclone barrel, thus facilitating air cycle in the dust-collection container and further improves the dust collection capacity of the dust collector.

In some embodiments, the cyclone barrel is mounted onto the dust-collection container via screws or integral with the dust-collection container. Thus, the dust collector has a simple structure, and it is easy to mount the dust-collection collector, thus improving the assembling efficiency of the dust collector.

A cleaner according to embodiments of a second broad aspect of the present disclosure, includes the dust collector according to above embodiments of the present disclosure.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a perspective-sectional view of a dust collector for a cleaner according to an embodiment of the present disclosure;

FIG. 2 is an exploded view showing a dust-collection container and a cyclone barrel in an embodiment of the present disclosure;

FIG. 3 is a sectional view of a dust collector for a cleaner according to an embodiment of the present disclosure;

FIG. 4 is a schematic view illustrating a connection between a cyclone barrel and a dust-laden air tube according to an embodiment of the present disclosure;

FIG. 5 is a schematic view showing a cyclone barrel, a dust-laden air tube and a dust baffle according to a first embodiment of the present disclosure;

FIG. 6 is a schematic view showing a cyclone barrel, a dust-laden air tube and a dust baffle according to a second embodiment of the present disclosure;

FIG. 7 is a schematic view showing a cyclone barrel, a dust-laden air tube and a dust baffle according to a third embodiment of the present disclosure; and

FIG. 8 is a schematic view showing a rib in a dust-collection container according to an embodiment of the present disclosure.

### DETAILED DESCRIPTION

Reference will be made in detail to embodiments of the present disclosure. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” ,“inner”, “outer”, “clockwise”, “anticlockwise” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

In addition, terms such as “first” and “second” are used herein for purposes of description and are not intended to indicate or imply relative importance or significance. Thus, features limited by “first” and “second” are intended to indicate or imply including one or more than one these features. In the description of the present disclosure, “a plurality of” relates to two or more than two.

In the description of the present disclosure, unless specified or limited otherwise, it should be noted that, terms “mounted,” “connected” “coupled” and “fastened” may be understood broadly, such as permanent connection or detachable connection, electronic connection or mechanical connection, direct connection or indirect connection via intermediary, inner communication or interreaction between two elements. These having ordinary skills in the art should understand the specific meanings in the present disclosure according to specific situations.

In the description of the present disclosure, a structure in which a first feature is “on” a second feature may include an embodiment in which the first feature directly contacts the second feature, and may also include an embodiment in which an additional feature is formed between the first feature and the second feature so that the first feature does not directly contact the second feature, unless otherwise specified. Furthermore, a first feature “on,” “above,” or “on top of” a second feature may include an embodiment in which the first feature is right “on,” “above,” or “on top of” the second feature, and may also include an embodiment in which the first feature is not right “on,” “above,” or “on top of” the second feature, or just means that the first feature has a sea level elevation larger than the sea level elevation of the second feature. While first feature “beneath,” “below,” or “on bottom of” a second feature may include an embodiment in which the first feature is right “beneath,” “below,” or “on bottom of” the second feature, and may also include an embodiment in which the first feature is not right “beneath,” “below,” or “on bottom of” the second feature, or just means that the first feature has a sea level elevation smaller than the sea level elevation of the second feature.

The dust collector in the art includes a dust-collection container, a cyclone barrel disposed in the dust-collection container, a filter disposed in the cyclone barrel and a dust-laden air tube communicating the filter with the dust-collection container. In the dust collector in the related art, a dust depositing area is formed between an outer wall of the cyclone barrel and an outer wall of dust-laden air tube, and the dust discharged from the cyclone barrel via air holes tends to be deposited in the depositing area. Since the cyclone barrel and the dust-collection container are fixed together, it is difficult to clean the dust in the depositing area.

The dust collector according to embodiments of the present disclosure will be described in the following with reference to drawings.

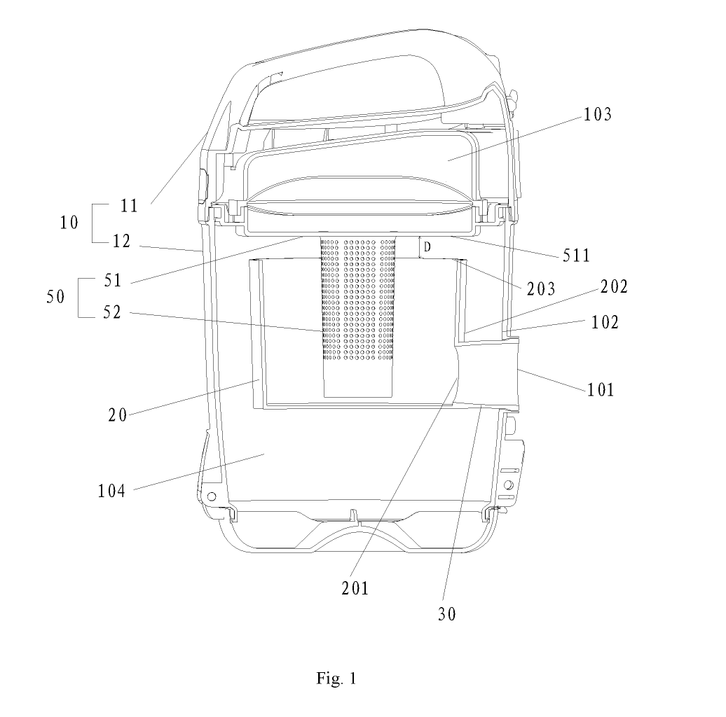

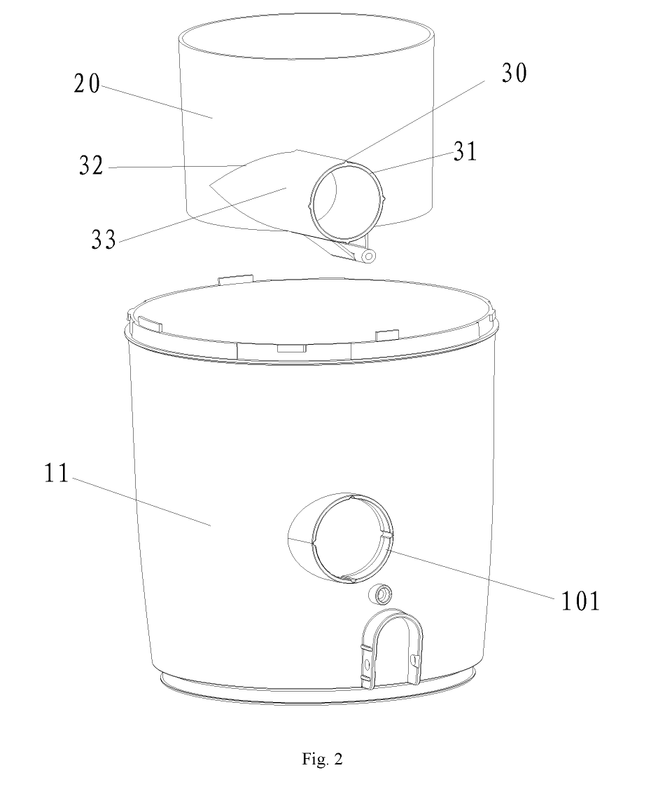

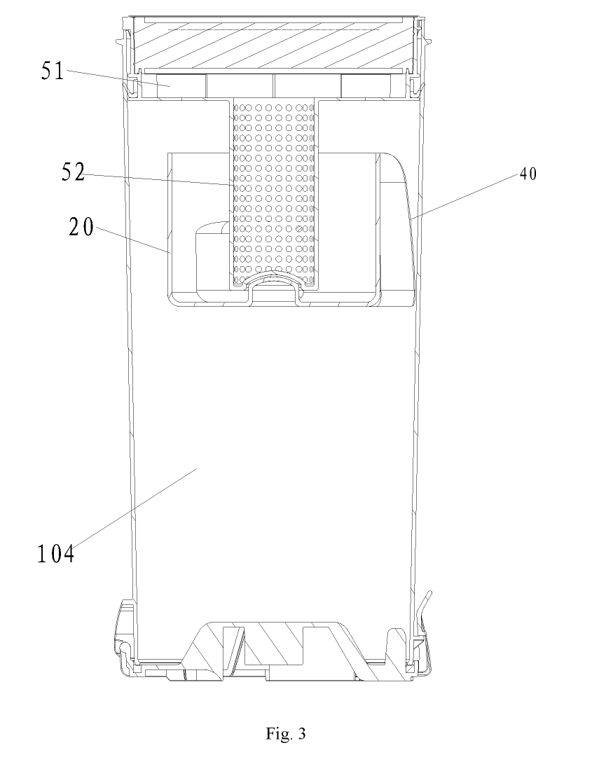

As shown in FIGS. 1 to 7, the dust collector according to embodiments of the present disclosure includes a dust-collection container 10, a cyclone barrel 20, a dust-laden air tube 30 and a dust baffle 40.

As shown in FIGS. 1 to 3, the dust-collection container 10 has an inner chamber therein, a dust-laden air inlet 101 and air outlet 105. The dust-laden air enters into the cyclone barrel 20 via the dust-laden air inlet 101. The cyclone barrel 20 is disposed in the inner chamber in the dust-collection container 10 and used to separate the dust from the dust-laden air entering into the cyclone barrel 20 via the dust-laden air inlet 101. The cyclone barrel 20 has an air inlet 201 formed in a side wall of the cyclone barrel 20. The dust-laden air tube 30 has a first end 31 connected to the dust-laden air inlet 101 and a second end 32 connected to the cyclone barrel air inlet 201.

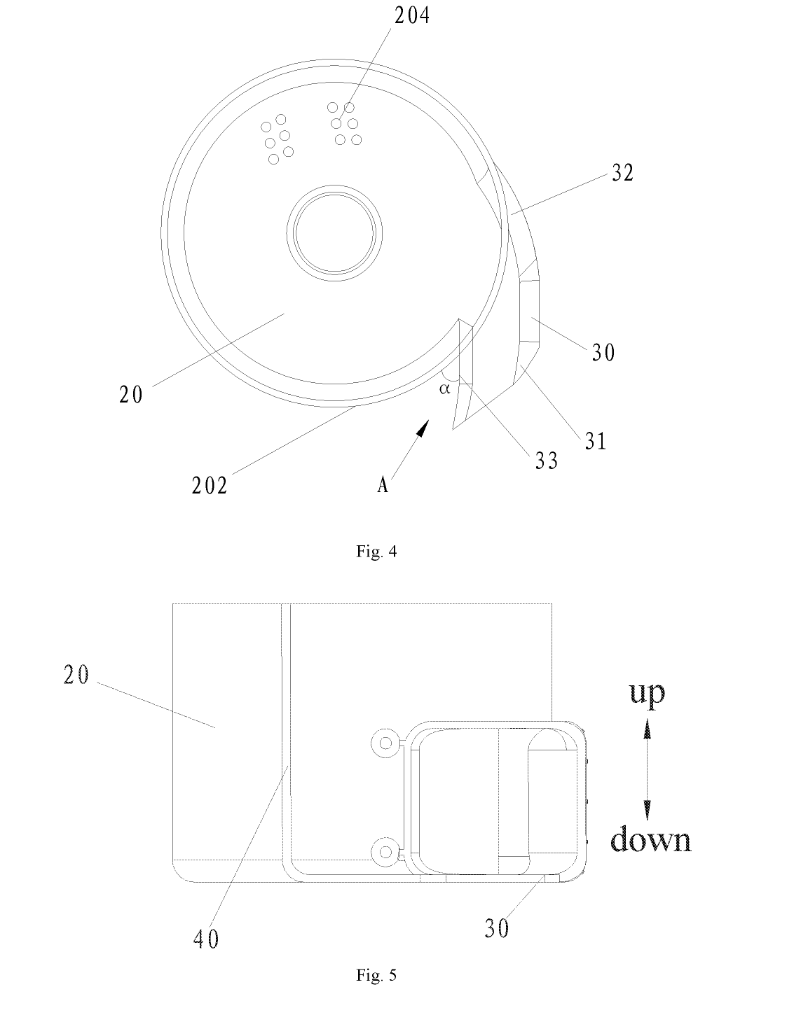

As shown in FIG. 4, a dust depositing area A is formed between the outer wall 202 of the cyclone barrel 20 and an outer wall 33 of dust-laden air tube 30. An included angle a, less than 90 degrees, is formed between the outer wall 202 of the cyclone barrel 20 and the outer wall 33 of dust-laden air tube 30. As described above, the dust tends to be accumulated in the dust depositing area A when the dust enters into the dust depositing area A.

The dust baffle 40 is disposed between an outer wall 202 of the cyclone barrel 20 and an inner wall 102 of the dust-collection container 10 to shield the dust depositing area, so that the dust is prevented from depositing in the dust depositing area A.

With disposing the dust baffle 40 between the outer wall 202 of the cyclone barrel 20 and the inner wall 102 of the dust-collection container 10, the dust depositing area A is shielded and separated from the dust in the dust-laden air collected in the dust-collection container. Thus, the dust cannot enter into and be deposited in the dust depositing area, so that the dust collector is easy to clean.

In some embodiments, the dust baffle 40 may be only connected with the inner wall 102 of the dust-collection container 10 and contacted with the outer wall 202 of the cyclone barrel 20. Thus simplifying the structure and assembling process of the cyclone barrel 20.

Alternately, the dust baffle 40 may be only connected with the outer wall 202 of the cyclone barrel 20 and contacted with the inner wall 102 of the dust-collection container 10.

As shown in FIG. 5, the dust baffle 40 may be disposed and extended in a vertical direction (i.e., the up-down direction shown in FIG. 5). Thus, the structure of the dust baffle 40 is simplified and conveniently to be assembled.

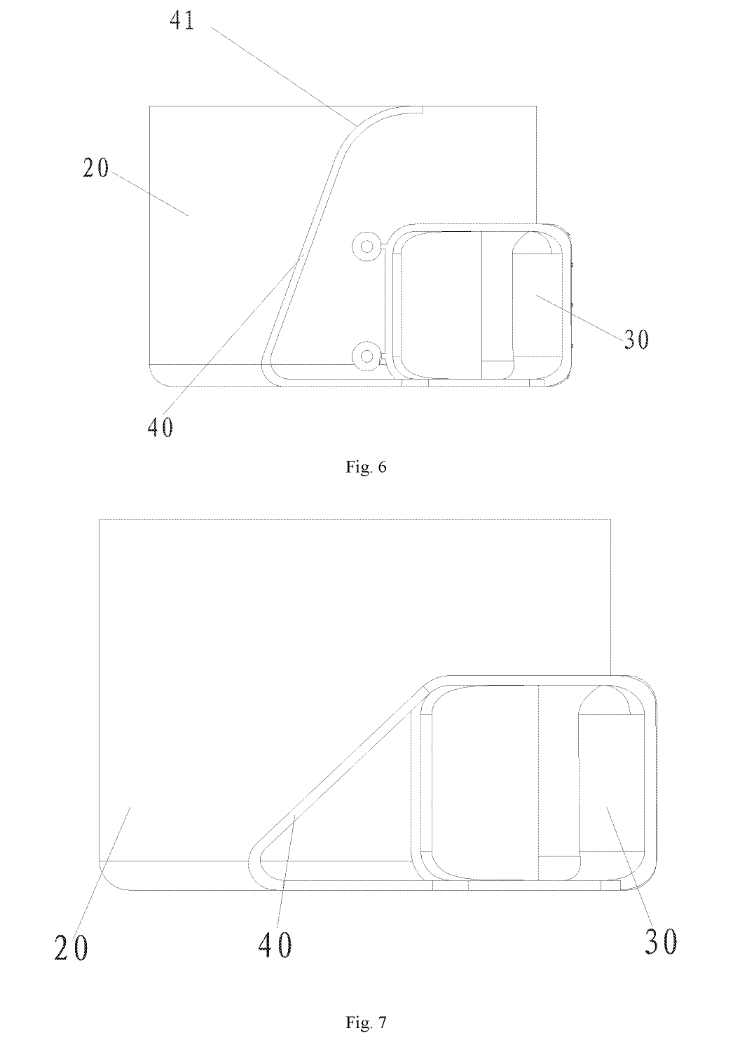

Alternately, as shown in FIG. 6, an upper segment 41 of the dust baffle 40 may be an arc segment and extended toward the dust-laden air tube 30, namely, the upper end of the dust baffle 40 is inclined toward the dust-laden air tube 30 and covers up a part of the upper surface of the dust-laden air tube 30. Thus, the dust can be prevented from entering the dust depositing area A from above. Moreover, as shown in FIG. 7, the upper end of the dust baffle 40 is connected with the outer wall 33 of the dust-laden air tube 30, namely, the upper end of the dust baffle 40 is inclined toward the dust-laden air tube 30 and coupled to the dust-laden air tube 30. Thus the dust can be prevented from entering the dust depositing area A from above.

In addition, the dust baffle 40 may be an arc plate. An upper end and a lower end of the arc plate are bent toward the dust-laden air tube 30. Alternately, the dust depositing area A is formed as an area closed by the dust baffle 40, the cyclone barrel 20 and dust-laden air tube 30, Thus the dust is prevented from entering the dust depositing area A to the maximal extent.

In some embodiments, as shown in FIG. 1, a filter 50 is disposed in the dust-collection container 10, and has a filtering cup 52 and a flange 51 disposed on an upper end of the filter cup 52. The flange 51 is connected with an inner wall of the dust-collection container 10 so as to divide the inner chamber into a first chamber 103 communicated with the air outlet 105 and a second chamber 104.

The cyclone barrel 20 is disposed in the second chamber 104 and separates the dust from the dust-laden air. The cyclone barrel 20 has an air inlet 201 communicated with the dust-laden air inlet 101 via a dust-laden air tube 40, such that the clean air separated from dust by the filter 30 can pass through the second chamber 104 and the first chamber 103 in turns, and finally be discharged from the dust-collection container 10. Moreover, the air inlet 201 may be formed in a side wall of the cyclone barrel 20 and the barrel 20 has an open upper end 202 and a closed lower end 203.

In some embodiments, a lower end of the filter cup 32 is extended into the cyclone barrel 20 through the open upper end 202 of the cyclone barrel 20, and the open upper end 202 of cyclone barrel 20 is spaced apart from a lower surface 511 of the flange 51, in other words, an annular gap D is form between the upper end 201 of the cyclone barrel 20 and a lower surface 511 of the flange 51.

The rubbish, such as facial tissue, can pass through the gap D between the upper end 201 of the cyclone barrel and the lower surface 511 of the flange 51 and be collected in the dust-collection container 10, so that the cyclone barrel 20 cannot be blocked and the reliability of the dust collector is improved. Furthermore, the gap D also improves the separating performance of the dust collector.

A distance between the lower surface 511 of the flange 51 and the upper end 202 of the cyclone barrel 20 ranges from 10 mm to 35 mm, namely a height of the gap D ranges from 10 mm to 35 mm, thus improving the duct collecting performance of the dust collector. In addition, an assemble process of the dust collector is simplified and an assembling efficiency of the dust collector is improved.

In some embodiments, as shown in FIG. 1, the dust-collection container 10 may include a body 11 and a cover 12. The body 11 has an open upper end and the cover 12 is detachably coupled to the body 11 to close the upper end of the body 11, and the air outlet 102 may be formed in the cover 12. Therefore, the detachable cover 12 can facilitate assembling cyclone barrel 20 in the dust-collection container 10, and the structure of body 11 and cover 12 can reduce the difficulty and cost of manufacturing.

An air deflector is disposed in an upper part of the inner chamber, guides the air downward the lower part of the dust-collation container 10. In other words, the air deflector is disposed on the body 11 or the cover 12.

As shown in FIG. 1, the air deflector is disposed on a lower surface of the cover 12 and extended from the lower surface of the cover 10 inward the body 11

Alternately, the air deflector is disposed an inner wall of the body 11. Thus, the air is guided toward the lower part of the dust-collection container 10, thus improving the dust collection efficiency.

The air deflector is spaced apart from the inner wall of the body 11 and disposed at a side away from the dust baffle 40, thus further improving guiding effect of the air in the dust-collection container 10.

As shown in FIG. 4, a plurality of air holes 204 are formed in a bottom wall of the cyclone barrel 20 and away from the air inlet 201 of the cyclone barrel 20, which facilitates air circulation in the dust-collection container 10 and further improves the dust collection performance of the dust collector.

In some embodiments, the cyclone barrel 20 may be mounted onto the body 11 via screws. Therefore, it is easy to assemble and disassemble the dust-collection container 10 and the cyclone barrel 20, which not only improves the assembling efficiency of the dust collector, but also facilitates maintenance of the dust collector, thus reducing the maintenance cost.

In addition, the cyclone barrel 20 and the body 11 may be formed integrally. Therefore, the dust collector is easy to be manufactured and assembled, which not only improves the sealing effect of the dust collector, but also reduces the manufacturing cost of the dust collector.

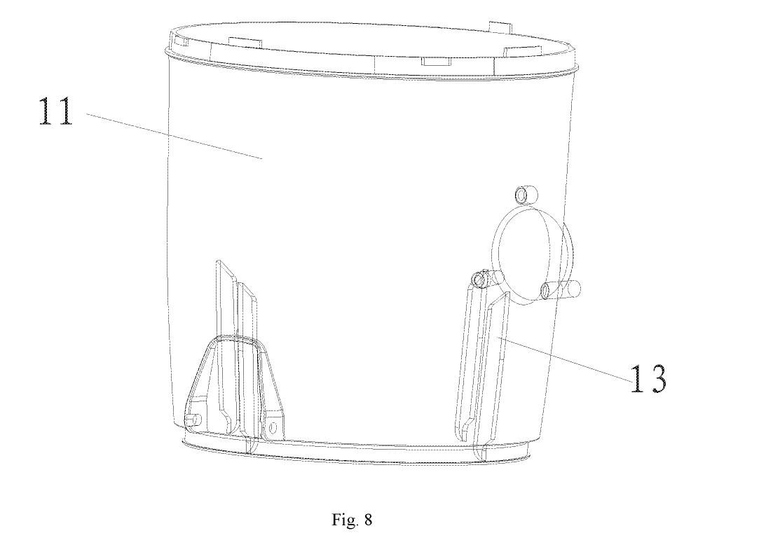

As shown in FIG. 8, a rib 13 may be disposed on at least one of a side wall and a bottom wall of the second chamber 104, which facilitates the dust to be accumulated at the lower part within the dust-collection container 10 quickly, thus improving the dust collection effect.

In some embodiments, a plurality of ribs 13 are arranged in a circumferential direction of the dust-collection container 10.

The plurality of ribs 13 such as four ribs are disposed at a lower part of the side wall of the dust-collection container 10, and arranged in a circumferential direction of the dust-collection container 10. An end of the rib 13 is connected with the side wall of the dust-collection container 10, and the other end of the rib 13 is extended inward in the dust-collection container 10. In other words, the ribs 13 are connected with the side wall of the dust-collection container 10, and extended toward a central axis of the dust-collection container 10.

Alternately, the rib 13 is connected with the side wall of the dust-collection container 10 and is perpendicular to the inner side wall of the dust-collection container 10. Therefore, the rib is disposed in the dust-collection container 10 and blocks the air circulated in the dust collector, thus facilitating accumulating of the dust at the lower end of the dust-collection container 10 quickly, thus improving the dust collection efficiency of the dust collector.

In addition, as shown in FIG. 5, the dust collector according to embodiments of the present disclosure further includes a filter cotton and a sealing ring, in order to further improve sealing performance of the dust-collection container 10.

A cleaner according to embodiments of the present disclosure includes the dust collector as described in the above embodiments of the present disclosure.

With the dust collector of the embodiments of the present disclosure, by disposing the dust baffle between an outer wall of the cyclone barrel and an inner wall of the dust-collection container, the dust depositing area is covered up and separated from the dust collected in the dust-collection container. Thus, the dust cannot enter into and be deposited in the dust depositing area, and the dust collector is convenient to clean and the service life of the cleaner is increased.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A dust collector for a cleaner, comprising:
a dust-collection container defining an inner chamber therein and having a dust-laden air inlet and air outlet;
a cyclone barrel disposed in the inner chamber and having an air inlet formed in a side wall of the cyclone barrel;
a dust-laden air tube defining a first end connected to the dust-laden air inlet and a second end connected to the cyclone barrel air inlet; and
a dust baffle disposed between an outer wall of the cyclone barrel and an inner wall of the dust-collection container to cover up a dust depositing area formed between the outer wall of the cyclone barrel and an outer wall of dust-laden air tube.

2. The dust collector according to claim 1, wherein an included angle formed between the outer wall of the cyclone barrel and the outer wall of dust-laden air tube within the dust depositing area is smaller than 90 degrees.

3. The dust collector according to claim 1, wherein the dust baffle is connected with the outer wall of the cyclone barrel and contacted with the inner wall of the dust-collection container.

4. The dust collector according to claim 1, wherein the dust baffle is connected with the inner wall of the dust-collection container and contacted with the outer wall of the cyclone barrel.

5. The dust collector according to claim 1, wherein the dust baffle is disposed in a vertical direction.

6. The dust collector according to claim 1, wherein an upper end of the dust baffle is inclined toward the dust-laden air tube.

7. The dust collector according to claim 6, wherein the upper end of the dust baffle is connected with the outer wall of the dust-laden air tube.

8. The dust collector according to claim 1, wherein a plurality of air holes are formed in a bottom wall of the cyclone barrel.

9. The dust collector according to claim 1, wherein the cyclone barrel is mounted onto the dust-collection container via screws or integral with the dust-collection container.

10. The dust collector according to claim 1, wherein a filter is disposed in the dust-collection container and has a filtering cup and a flange disposed on an upper end of the filter cup, the flange is connected with an inner wall of the dust-collection container so as to divide the inner chamber into a first chamber communicated with the air outlet and a second chamber,
wherein the cyclone barrel is disposed in the second chamber, a lower end of the filter cup is extended into the cyclone barrel through an open upper end of the cyclone barrel, and the open upper end of the cyclone barrel is spaced apart from a lower surface (511) of the flange.

11. The dust collector according to claim 10, wherein a distance between the lower surface of the flange and the upper end of the cyclone barrel ranges from 10 mm to 35 mm.

12. The dust collector according to claim 10, wherein the dust-collection container comprises a body having an open upper end and a cover detachably coupled to the body to closes the upper end of the body, and the air outlet is formed in the cover.

13. A cleaner comprising a dust collector, wherein the dust collector, comprises:
a dust-collection container defining an inner chamber therein and having a dust-laden air inlet and air outlet;
a cyclone barrel disposed in the inner chamber and having an air inlet formed in a side wall of the cyclone barrel;
a dust-laden air tube defining a first end connected to the dust-laden air inlet and a second end connected to the cyclone barrel air inlet; and
a dust baffle disposed between an outer wall of the cyclone barrel and an inner wall of the dust-collection container to cover up a dust depositing area formed between the outer wall of the cyclone barrel and an outer wall of dust-laden air tube.

14. The cleaner according to claim 13, wherein an included angle formed between the outer wall of the cyclone barrel and the outer wall of dust-laden air tube within the dust depositing area is smaller than 90 degrees.

15. The cleaner according to claim 13, wherein the dust baffle is connected with the outer wall of the cyclone barrel and contacted with the inner wall of the dust-collection container.

16. The cleaner according to claim 13, wherein the dust baffle is connected with the inner wall of the dust-collection container and contacted with the outer wall of the cyclone barrel.

17. The cleaner according to claim 13, wherein the dust baffle is disposed in a vertical direction.

18. The cleaner according to claim 13, wherein an upper end of the dust baffle is inclined toward the dust-laden air tube.

19. The cleaner according to claim 13 wherein the upper end of the dust baffle is connected with the outer wall of the dust-laden air tube.

20. The cleaner according claim 13, wherein a filter is disposed in the dust-collection container and has a filtering cup and a flange disposed on an upper end of the filter cup, the flange is connected with an inner wall of the dust-collection container so as to divide the inner chamber into a first chamber communicated with the air outlet and a second chamber,
wherein the cyclone barrel is disposed in the second chamber, a lower end of the filter cup is extended into the cyclone barrel through an open upper end of the cyclone barrel, and the open upper end of the cyclone barrel is spaced apart from a lower surface of the flange.
